(19) United States
(12) Patent Application Publication
(10) Pub. No.: US 2021/0187848 A1
(43) Pub. Date: Jun. 24, 2021

(54) POWDER CONTAINER

(71) Applicant: HEWLETT-PACKARD DEVELOPMENT COMPANY, L.P., Houston, TX (US)

(72) Inventors: Brent C. EWALD, Vancouver, WA (US); Wesley R. SCHALK, Vancouver, WA (US)

(73) Assignee: HEWLETT-PACKARD DEVELOPMENT COMPANY, L.P., Houston, TX (US)

(21) Appl. No.: 16/074,396

(22) PCT Filed: Sep. 22, 2016
(86) PCT No.: PCT/US2016/053123

§ 371 Date: Jul. 31, 2018

(51) Int. Cl. B29C 64/255; B33Y 30/00; B33Y 40/00; B29C 64/321

(52) U.S. Cl. CPC B29C 64/255; B29C 64/321; B33Y 40/00; B33Y 30/00

(57) ABSTRACT

In one example, a powder supply container includes an interior chamber to contain powder, a first basin in the chamber, an outlet from the chamber in the first basin, a second basin in the chamber, and a stallable lift inside the chamber to lift powder out of the second basin into the first basin. The lift is to stall at a stall threshold in which powder in the container prevents the lift from lifting.

### BACKGROUND

Additive manufacturing machines, sometimes called 3D printers, produce objects by building up layers of material. Digital data may be processed into slices each defining that part of a layer or layers of build material to be formed into the object. In some additive manufacturing machines, the object slices are formed in a powdered build material spread in layers over the work area. Powder in each of the successive layers may be fused in the desired pattern to form a solid object.

### DRAWINGS

FIGS. 1 and 2 are isometric views illustrating one example of a powder container.

FIG. 3 is a section view taken along the line 3-3 in FIG. 2.

FIG. 4 is an isometric and partial section view of the example container shown in FIGS. 1-3.

FIGS. 5-8 present a sequence of side section views illustrating a supply operation in the example container shown in FIGS. 1-4.

FIG. 9 is a front section view detail illustrating the example container shown in FIGS. 1-4 during a supply operation.

FIGS. 10-15 are side and front elevation views illustrating examples of a vane configuration for the lift in a powder container such as that shown in FIGS. 1-4.

FIGS. 16 and 17 are side section views illustrating a supply operation in a powder container using the example vane configuration shown in FIGS. 14 and 15.

FIGS. 18-23 are side and front elevation views illustrating other examples of a vane configuration for the lift in a powder container such as that shown in FIGS. 1-4.

FIG. 24 is a section view illustrating another example of a powder container.

The same part numbers designate the same or similar parts throughout the figures. The figures are not necessarily to scale.

### DESCRIPTION

It may be desirable to minimize the height of some additive manufacturing machines. In machines that use gravity to deliver the powdered build material to the manufacturing zone, powder supply containers are located above the manufacturing zone. The height of the machine, therefore, can be effected by the height of the powder supplies. A new, compact powder supply container has been developed to help reduce the effect of the powder supply on the height of an additive manufacturing machine. In one example, a powder supply container includes forward and rearward troughs in plane with one another along the bottom of the supply chamber. An auger in the forward trough conveys powder to the outlet while a sweep in the rearward trough sweeps powder from the rearward trough into the forward trough.

A swept trough configuration enables powder to be stored in the container at a lower level than is possible if gravity alone is used to feed powder to the auger, allowing an equal supply capacity in a shorter container or an increased supply capacity in the same height container. The reduced height (or increased capacity) can be significant. For example, a PA12 build material powder may require a slope of 32° or more along the bottom of the container to reliably feed powder toward the outlet. A swept trough container with the same horizontal footprint, by comparison, could be 20% shorter and still achieve the same supply capacity. Conversely, a swept trough container the same height as a gravity feed container could hold 20% more powder within the same horizontal footprint.

While examples of the new container were developed to supply powdered build materials for additive manufacturing, examples are not limited to additive manufacturing. The examples described herein and shown in the figures illustrate but do not limit the scope of the patent, which is defined in the Claims following this Description.

As used in this document, “and/or” means one or more of the connected things.

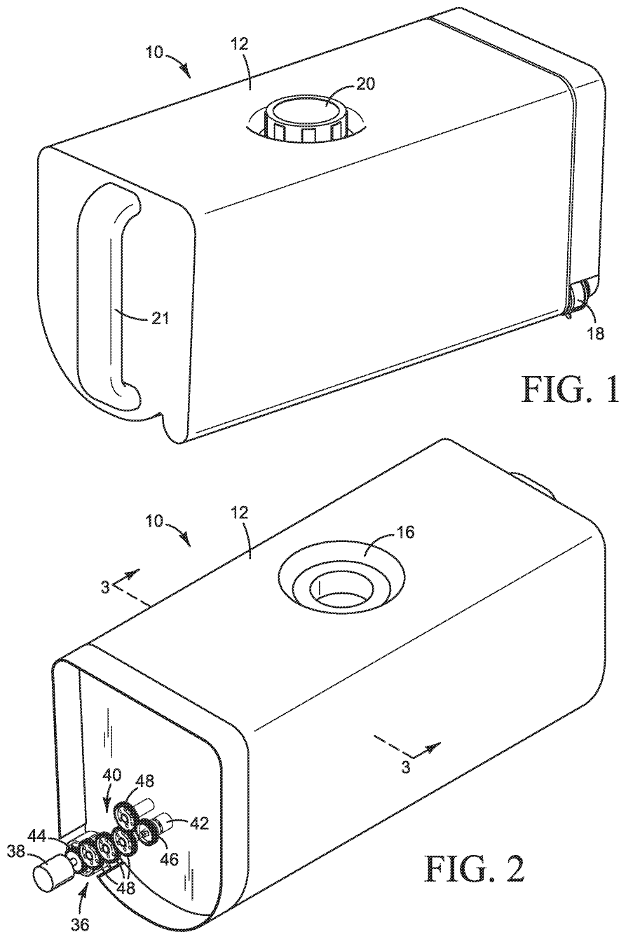

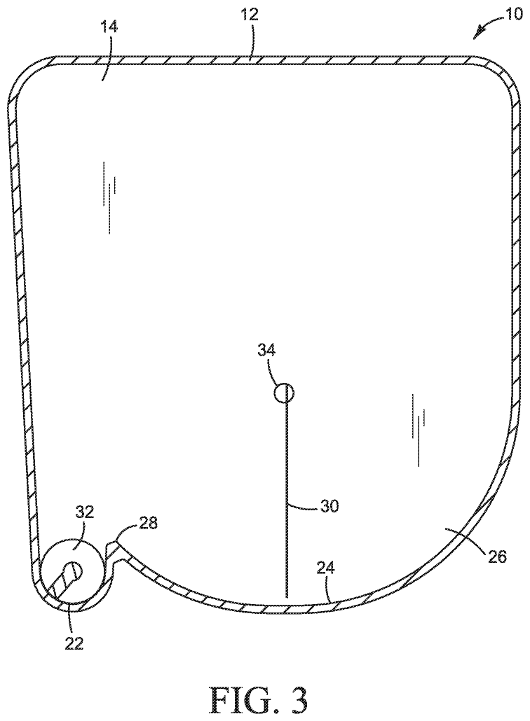

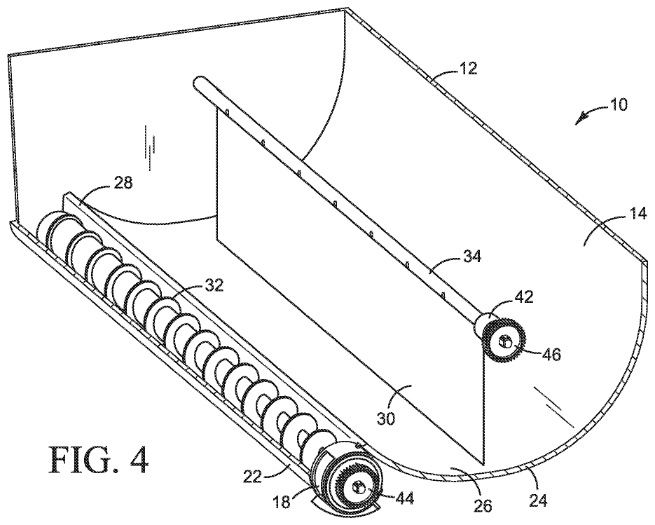

FIGS. 1 and 2 are isometric views illustrating one example of a powder container 10, such as might be used to supply powdered build material in an additive manufacturing machine. FIG. 3 is a section view taken along the line 3-3 in FIG. 2. FIG. 4 is an isometric and partial section view of container 10 shown in FIGS. 1-3. Referring to FIGS. 1-4, container 10 includes a housing 12 that defines an interior chamber 14 to hold a powder, an inlet 16 to chamber 14, and an outlet 18 from chamber 14. A cap 20 caps inlet 16 in FIG. 1. A portable container 10 may include a handle 21, shown in FIG. 1.

A first basin 22 and a second basin 24 are formed at the bottom part 26 of interior chamber 14. Basins 22 and 24 are separated by a spillway 28. In this example, first basin 22 is located forward of second basin 24 in the direction powder is moved toward outlet 18 (from basin 24 into basin 22 to outlet 18). For an elongated powder supply chamber 14 shown in FIGS. 1-4, each basin 22, 24 is configured as a trough that extends the full width of the bottom part 26 of chamber 14. In this example, outlet 18 is a point outlet located at one end of forward trough 22. In other examples, outlet 18 may be configured as a line outlet extending along the bottom of trough 22.

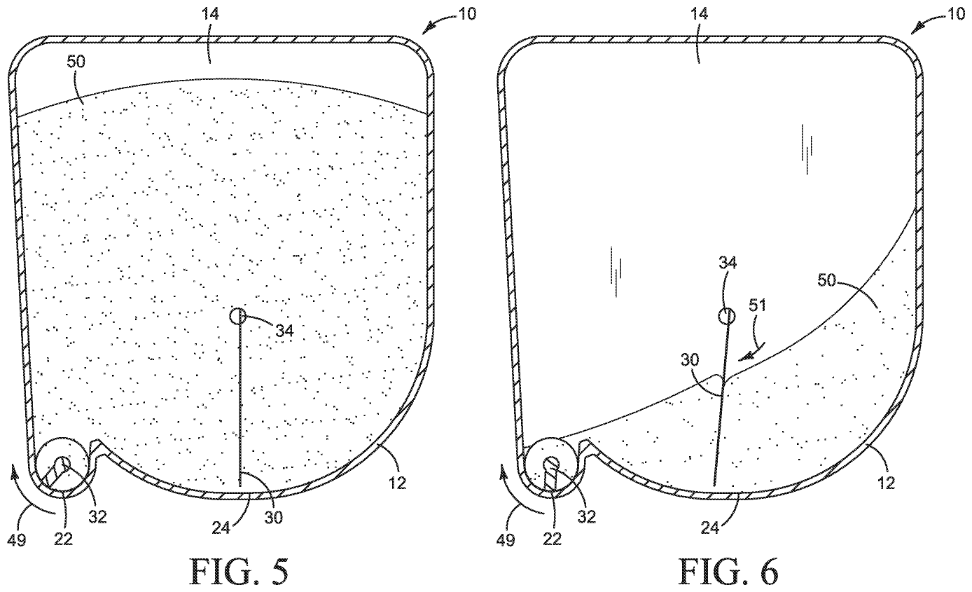

As shown in FIGS. 3 and 4, container 10 includes a lift 30 mounted to housing 12 to lift powder out of rearward trough 24 into forward trough 22. As described in detail below with reference to FIGS. 5-8, in this example lift 30 is configured as a sweep that rotates through trough 24 to sweep powder up and over spillway 28 into forward trough 22. Also in this example, an auger 32 is mounted to housing 12 in forward trough 22 to convey powder along trough 22 to outlet 18.

Sweep 30 is mounted to a shaft 34 operatively connected to a drive mechanism 36 to rotate shaft 34. Drive mechanism 36 includes a motor 38 and a drive train 40 connecting motor 38 to sweep shaft 34. In this example, as shown in FIG. 2, a single motor 38 drives sweep 30 and auger 32. Sweep drive train 40 includes a torque limiter 42 to keep the drive torque applied to sweep shaft 34 predictably below a desired threshold, thus allowing sweep 30 to stall when the powder inside chamber 14 is deep enough to gravity feed into forward trough 22 while still allowing auger 32 to auger powder toward outlet 18. The stall threshold may be set, for example, based on the characteristics of the powder to be supplied from chamber 14, the surface area of sweep 30, and the depth of the rearward trough 24.

Drive train 40 also includes drive gears 44, 46 connected through a series of idler gears 48. Idler gears 48 are omitted from drive train 40 in FIG. 4 to more clearly show sweep 30 in trough 24. Other configurations for drive mechanism 36 are possible. For example, sweep 30 and auger 32 could be driven independently of one another and more or fewer drive gears and/or idler gears could be used.

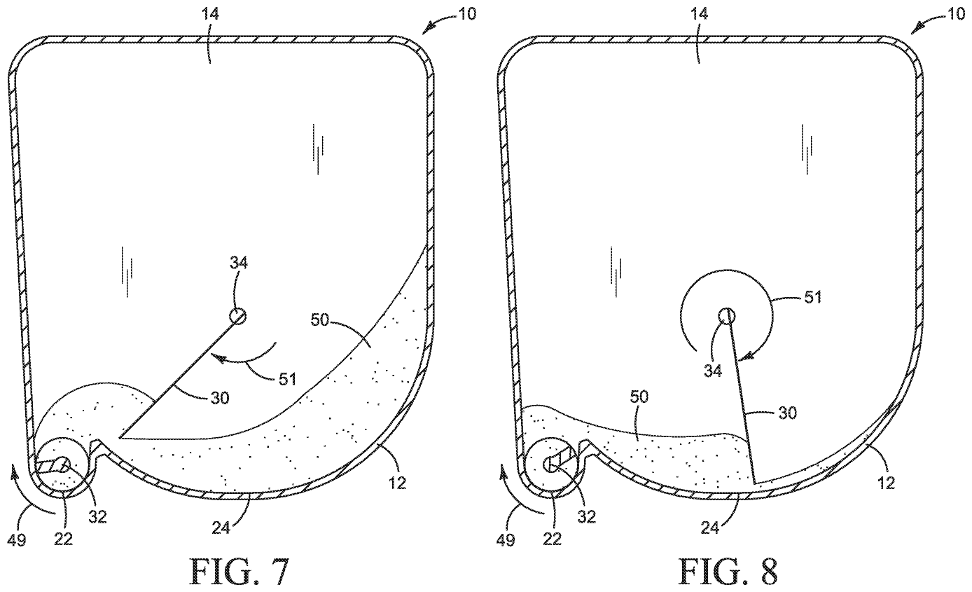

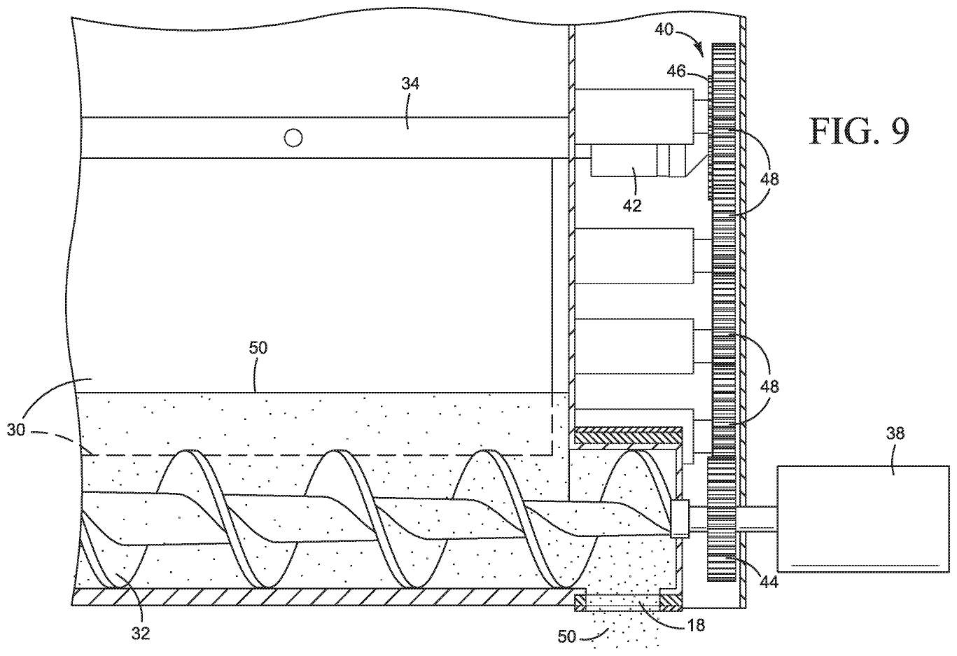

FIGS. 5-8 present a sequence of side section views illustrating a supply operation using a container 10 shown in FIGS. 1-4. FIG. 9 is a front section view detail illustrating the example container 10 during a supply operation. In FIG. 5, the level of powder 50 in chamber 14 is high enough to gravity feed into forward trough 22. Thus, sweep 30 is stalled and auger 32 is turning, as indicated by rotation arrow 49 in FIG. 5, to auger powder 50 to an open outlet 18 (shown in FIG. 9). In FIG. 6, the level of powder 50 in chamber 14 has dropped to a level that allows sweep 30 to turn, as indicated by rotation arrow 51, to sweep powder 50 over spillway 28 into forward trough 22. Auger 32 continues to turn, augering powder 50 to outlet 18 as shown in FIG. 9. Sweep 30 may be rotated continuously or intermittently to sweep powder 50 out of rearward trough 24 into forward trough 22 as shown in FIGS. 7 and 8 until the supply of powder 50 is exhausted.

As best seen in the section views of FIGS. 3 and 5-8, in this example the bottom of troughs 22, 24 lie in the same plane (and sink to the same depths) to help maximize the powder supply capacity within the 3D space occupied by container 10 and enabling higher volumetric efficiencies compared to a gravity feed supply.

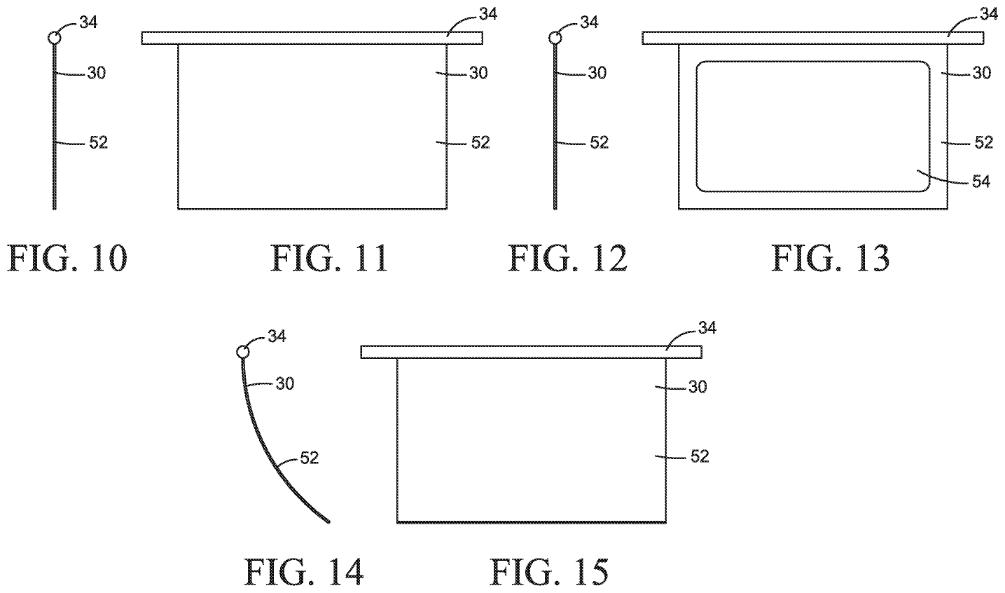

FIGS. 10-15 are side and front elevation views illustrating examples of the vane configuration for a sweep or other lift 30 in a powder container 10. In the example shown in FIGS. 10 and 11, lift 30 is configured as a straight rectangular solid vane 52. In the example shown in FIGS. 12 and 13, lift 30 is configured as a straight rectangular apertured vane 52 with a single opening 54. An apertured vane 52 may be desirable in some implementations, for example, to help tune the stall threshold, lift capacity and/or agitating function of lift 30.

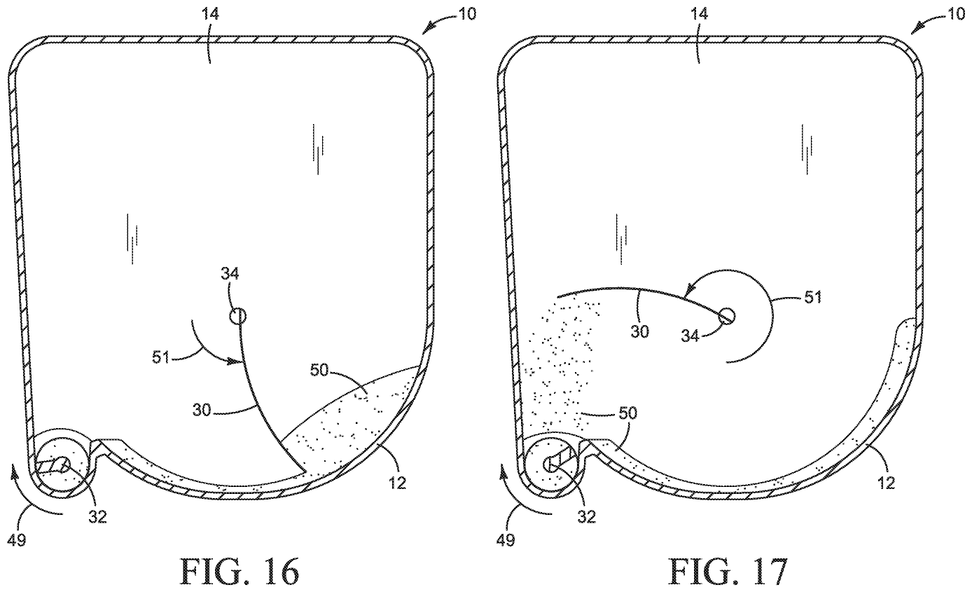

In the example shown in FIGS. 14 and 15, lift 30 is configured as a curved rectangular solid vane 52. As shown in FIGS. 16 and 17, a “scooped” lift 30 with a curved vane 52 such as that shown in FIGS. 14 and 15 may be rotated counter-clockwise through rearward trough 24 in chamber 14 to scoop up powder 50 and dump it into forward trough 22.

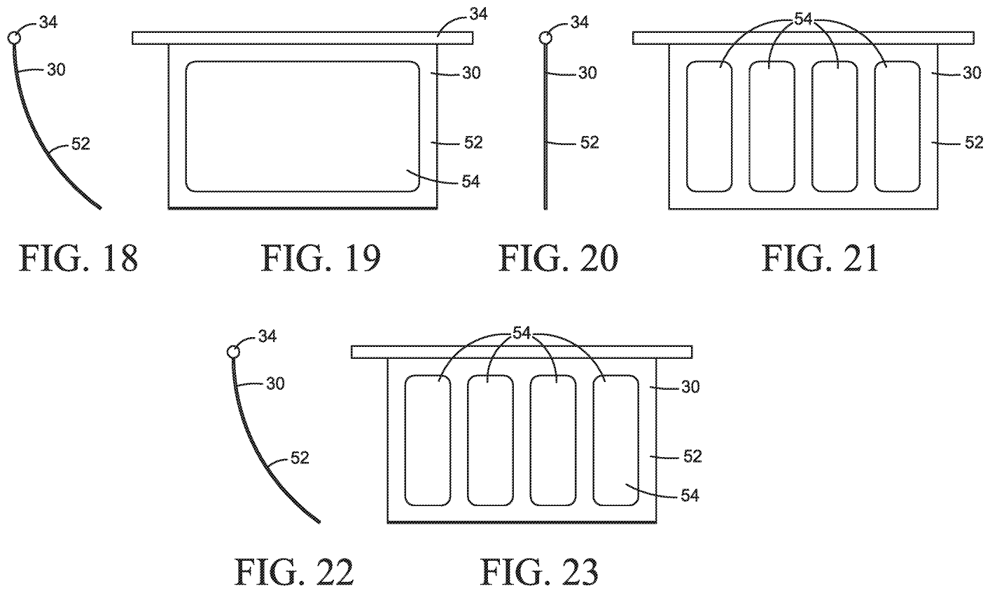

FIGS. 18-23 are side and front elevation views illustrating other examples of a vane configuration for the lift in a powder container 10. In the example shown in FIGS. 18 and 19, lift 30 is configured as a curved rectangular apertured vane 52 with a single opening 54. In the examples shown in FIGS. 20-23, lift 30 is configured as a straight (FIGS. 20 and 21) or curved (FIGS. 22 and 23) rectangular apertured vane 52 with multiple openings 54. For an apertured vane 52, the size, shape and number of openings 54 may be varied to achieve the desired degree of stall, lift and/or agitation. Also, while a lift 30 with a single vane 52 is shown, lift 30 may include multiple vanes 52, for example to increase the sweep frequency for a more continuous supply of powder to the auger as the supply of powder is depleted.

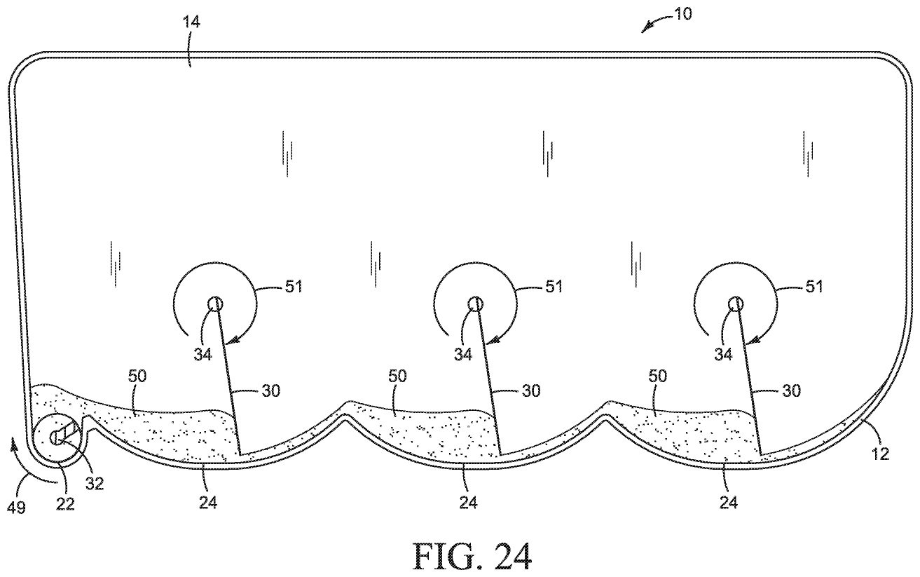

FIG. 24 illustrates another example of a powder supply container 10, in which multiple troughs 24 and multiple sweeps 30 are arranged in series so that powder 50 in one trough 24 is swept into the next trough 24 and so on until the last trough 24 in the series, from which powder 50 is swept into the forward, discharge trough 22. Although not shown in FIG. 24, single motor may be used to drive multiple sweeps through individual torque limiters to keep the drive torque applied to each sweep predictably below a desired threshold (as described above for a single sweep 30 in FIGS. 2 and 4).

As noted above, the examples shown in the figures and described herein illustrate but do not limit the patent, which is defined in the following Claims.

“A”, “an” and “the” used in the claims means one or more. For example, “a flap” means one or more flaps and “the flap” means the one or more flaps.

1. A powder supply container, comprising:
an interior chamber to contain powder;
a first basin in the chamber;
an outlet from the chamber in the first basin;
a second basin in the chamber; and
a stallable lift inside the chamber to lift powder out of the second basin into the first basin, the lift to stall at a stall threshold in which powder in the container prevents the lift from lifting.

2. The container of claim 1, comprising a drive train through which a drive torque may be applied to the lift, the drive train including a torque limiter to limit the drive torque to a drive torque corresponding to the stall threshold.

3. The container of claim 1, where the stall threshold is based on a characteristic of a powder to be contained in the chamber, a surface area of the lift, and a depth of the second basin.

4. The container of claim 1, where a bottom of the first basin and a bottom of the second basin lie in the same plane.

5. The container of claim 1, where:
the first basin comprises a first trough;
the second basin comprises a second trough; and
the lift comprises a sweep to sweep powder out of the second trough into the first trough.

6. The container of claim 1, where:
the first basin comprises a first trough;
the second basin comprises a second trough; and
the lift comprises a scoop to scoop powder out of the second trough into the first trough.

7. The container of claim 1, where the lift comprises an apertured vane having an opening therein through which powder may pass during lifting.

8. The container of claim 1, comprising powder contained in the chamber.

9. A replaceable powder supply container for an additive manufacturing machine, comprising:
a housing defining an interior chamber to hold a powdered build material, the interior chamber including a first trough along a bottom part of the chamber and a second trough along the bottom part of the chamber next to the first trough;
an outlet from the chamber at the first trough;
an auger mounted to the housing in the first trough to convey powder along the first trough toward the outlet; and
a rotatable sweep mounted to the housing in the second trough to sweep powder from the second trough into the first trough.

10. The container of claim 9, comprising a drive train operatively connected to the auger and to the sweep, the drive train connected to the sweep through a torque limiter to allow the sweep to stall while the auger turns.

11. The container of claim 10, where the drive train is a single drive train to drive the auger and the sweep simultaneously.

12. The container of claim 9, where:
the second trough comprises multiple second troughs; and
the sweep comprises multiple sweeps each in a corresponding one of the second troughs, the second troughs arranged in series so that powder in one second trough is swept into the next second trough in the series until the last second trough in the series from which powder is swept into the first trough.

13. The container of claim 12, comprising a single drive train to drive the auger and the sweeps simultaneously, the drive train connected to each sweep through a torque limiter to allow the sweep to stall while the auger turns.

14. A refillable powder supply for additive manufacturing build material, comprising:
an inlet through which the supply may be refilled with a powdered build material;
an outlet through which powdered build material may be discharged from the supply;
a basin at the bottom of the supply; and
a lift to lift powder out of the basin toward the outlet.

15. The container of claim 14, where the lift comprises a stallable sweep to sweep powder out of the basin toward the outlet.
